(19) United States
(12) Patent Application Publication
(10) Pub. No.: US 2025/0378704 A1
(43) Pub. Date: Dec. 11, 2025

(54) CAPTIONING FOR IMAGE PERSONALIZATION

(71) Applicant: ADOBE INC., SAN JOSE, CA (US)

(72) Inventors: Dhwanit Agarwal, SAN JOSE, CA (US); Nicholas Isaac Kolkin, Chicago, IL (US); Ambareesh Revanur, SAN JOSE, CA (US); Midhun Harikumar, Sunnyvale, CA (US); Shradha Agrawal, SAN JOSE, CA (US); Ajinkya Gorakhnath Kale, SAN JOSE, CA (US); Elya Shechtman, Seattle, WA (US); Jalansh Saumil Munshi, SAN JOSE, CA (US)

(21) Appl. No.: 18/736,289

(22) Filed: Jun. 6, 2024

(51) Int. Cl. G06V 20/70; G06F 40/166; G06F 40/279; G06F 40/40; G06V 10/74; G06V 10/764; G06V 10/774

(52) U.S. Cl. CPC G06V 20/70; G06F 40/166; G06F 40/279; G06F 40/40; G06V 10/761; G06V 10/764; G06V 10/774

(57) ABSTRACT

A method, apparatus, non-transitory computer readable medium, apparatus, and system for image processing include obtaining a plurality of images and a plurality of tags, wherein each of the plurality of tags represents a corresponding element of at least one of the plurality of images, computing a plurality of image-tag similarity scores, wherein each of the plurality of image-tag similarity scores indicate a similarity between one of the plurality of images and one of the plurality of tags, computing a plurality of classification scores corresponding to the plurality of tags, respectively, by averaging a subset of the plurality of image-tag similarity scores corresponding to each of the plurality of tags, and selecting a representative tag for the plurality of images based on the representative tag having a highest classification score among the plurality of classification scores.

### BACKGROUND

The following relates generally to image processing, and embodiments relate to generating representative tags for a set of images. Digital cameras and smartphones have become widely available, leading to a significant increase in the number of digital images captured and shared across various platforms. These images, which cover a wide range of subjects, can be organized and accessed based on associated tags or labels.

Machine learning models can be used to classify and categorize images. These machine learning models learn to recognize and extract features from training data, enabling these models to predict relevant tags or categories for new images. However, generating tags representative of a set of images presents additional challenges.

### SUMMARY

A method, apparatus, and non-transitory computer readable medium for captioning are described. One or more aspects of the method, apparatus, and non-transitory computer readable medium include obtaining a plurality of images and a plurality of tags, wherein each of the plurality of tags represents a corresponding element of at least one of the plurality of images; computing a plurality of image-tag similarity scores, wherein each of the plurality of image-tag similarity scores indicate a similarity between one of the plurality of images and one of the plurality of tags; computing a plurality of classification scores corresponding to the plurality of tags, respectively, by averaging a subset of the plurality of image-tag similarity scores corresponding to each of the plurality of tags; and selecting a representative tag for the plurality of images based on the representative tag having a highest classification score among the plurality of classification scores.

A method, apparatus, and non-transitory computer readable medium for captioning are described. One or more aspects of the method, apparatus, and non-transitory computer readable medium include obtaining an image and a plurality of tags, wherein each of the plurality of tags represents a corresponding element of the image; generating, using a natural language model, a plurality of image-tag descriptions based on the image and the plurality of tags, respectively, wherein each of the plurality of image-tag descriptions describes the corresponding element of the image; and generating, using the natural language model, a description of the image based on the plurality of image-tag descriptions.

An apparatus and method for captioning are described. One or more aspects of the apparatus and method include at least one processor; at least one memory storing instruction executable by the at least one processor; an image-tag similarity component including parameters stored in the at least one memory and configured to compute a plurality of image-tag similarity scores, wherein each of the plurality of image-tag similarity scores indicate a similarity between one of a plurality of images and one of a plurality of tags, wherein each of the plurality of tags represents a corresponding element of at least one of the plurality of images; a classification component including parameters stored in the at least one memory and configured to compute a plurality of classification scores corresponding to the plurality of tags, respectively, by averaging a subset of the plurality of image-tag similarity scores corresponding to each of the plurality of tags; and a selection component including parameters stored in the at least one memory and configured to generate a tag representing the plurality of images based on the tag having a highest classification score among the plurality of classification scores.

### BRIEF DESCRIPTION OF THE DRAWINGS

FIG. 1 shows an example of an image processing system according to aspects of the present disclosure.

FIG. 2 shows an example of an image processing application according to aspects of the present disclosure.

FIG. 3 shows an example of an image processing application according to aspects of the present disclosure.

FIG. 4 shows an example of an image processing apparatus according to aspects of the present disclosure.

FIG. 5 shows an example of an image processing model according to aspects of the present disclosure.

FIG. 6 shows a method for image processing according to aspects of the present disclosure.

FIG. 7 shows a method for natural language processing according to aspects of the present disclosure.

FIG. 8 shows examples of an image processing application according to aspects of the present disclosure.

FIG. 9 shows an example of a computing device according to aspects of the present disclosure.

### DETAILED DESCRIPTION

The following relates generally to image processing. Some embodiments relate to automated generation of representative tags for a set of images. Digital cameras and smartphones have become widely available, leading to a significant increase in the number of digital images captured and shared across various platforms. Images that cover a wide range of subjects can be organized and accessed based on associated tags or labels. Assigning descriptive tags to a large collection of images manually is a time-consuming and labor-intensive task.

Automated methods for generating image tags aim to automatically assign relevant tags to images based on visual content. Some automated methods utilize predefined categories or generate generic labels to describe the images. These methods analyze the visual content of the images and assign corresponding tags. The automatically generated tags are intended to provide a concise and informative representation of the image content, facilitating tasks such as image search, retrieval, and organization. The effectiveness of these automated methods depends on the ability to capture the most salient aspects of the images and generate specific and relevant tags that accurately describe the image content.

Embodiments of the present disclosure provide a method and apparatus for generating representative tags for a set of images. The method involves obtaining a plurality of images and their associated tags, where each tag represents a corresponding element of at least one of the images. A plurality of image-tag similarity scores is computed, indicating the similarity between each image and each tag. These similarity scores are calculated by encoding the images and tags into a multi-modal embedding space and computing the cosine similarity between the encoded image and the encoded tags in the multi-modal embedding space.

In some aspects, the dimensions of the image embeddings may be scaled based on their variance across the image set to emphasize the most informative dimensions. A plurality of classification scores is computed for each tag by averaging the image-tag similarity scores corresponding to that tag across the image set. The tag with the highest classification score is then selected as the representative tag for the set of images.

In some aspects, multiple components are employed to generate representative tags. A tag extraction component is utilized to generate initial tags for each image by generating captions and extracting relevant tags. This component may filter out stopwords to improve the quality of the extracted tags. An image-tag similarity component computes the relevance scores between the images and tags using advanced techniques such as multi-modal embedding and cosine similarity. A classification component analyzes the similarity scores and applies ranking and selection algorithms to determine the most representative tags for the entire image set. This component computes classification scores for each tag by summing the image-tag similarity scores over each image and dividing by the total number of images.

Embodiments of the present disclosure improve the accuracy of image classification systems by generating more relevant and specific tags for a set of images. For example, given a set of related images, the system can generate relevant and specific tags that accurately capture the salient aspects of the images. Improved accuracy is achieved by obtaining a plurality of images and corresponding tags, computing image-tag similarity scores to determine the relevance of each tag to each image, and then calculating classification scores for each tag by aggregating the similarity scores across the image set. The tag with the highest classification score is selected as the representative tag for the set of images.

Accordingly, the present disclosure includes the following aspects. A method for captioning is described. One or more aspects of the method include obtaining a plurality of images and a plurality of tags, wherein each of the plurality of tags represents a corresponding element of at least one of the plurality of images; computing a plurality of image-tag similarity scores, wherein each of the plurality of image-tag similarity scores indicate a similarity between one of the plurality of images and one of the plurality of tags; computing a plurality of classification scores corresponding to the plurality of tags, respectively, by averaging a subset of the plurality of image-tag similarity scores corresponding to each of the plurality of tags; and selecting a representative tag for the plurality of images based on the representative tag having a highest classification score among the plurality of classification scores.

Some examples of the method, apparatus, and non-transitory computer readable medium further include obtaining the plurality of tags comprises generating a plurality of captions corresponding to the plurality of images, respectively; and extracting the plurality of tags from the plurality of captions. Some examples of the method, apparatus, and non-transitory computer readable medium further include filtering the plurality of captions by removing a set of stopwords.

Some examples of the method, apparatus, and non-transitory computer readable medium further include computing the plurality of image-tag similarity scores comprises encoding each of the plurality of images and each of the plurality of tags to obtain a plurality of image embeddings and a plurality of text embeddings in a multi-modal embedding space; and computing a cosine similarity between each of the plurality of image embeddings and each of the plurality of text embeddings. Some examples of the method, apparatus, and non-transitory computer readable medium further include computing a measure of a variance of a dimension across the plurality of image embeddings for each of the plurality of tags. Some examples further include scaling the dimension of the plurality of image embeddings based on the measure of the variance.

Some examples of the method, apparatus, and non-transitory computer readable medium further include computing the plurality of classification scores further comprises computing, for each of the plurality of tags, a sum of the image-tag similarity scores over each of the plurality of images; and dividing the sum by a count of the plurality of images. Some examples of the method, apparatus, and non-transitory computer readable medium further include generating the representative tag comprises ranking the plurality of tags based on the corresponding classification scores; and selecting the representative tag based on the ranking.

A method for captioning is described. One or more aspects of the method include obtaining an image and a plurality of tags, wherein each of the plurality of tags represents a corresponding element of the image; generating, using a natural language model, a plurality of image-tag descriptions based on the image and the plurality of tags, respectively, wherein each of the plurality of image-tag descriptions describes the corresponding element of the image; and generating, using the natural language model, a description of the image based on the plurality of image-tag descriptions. Some examples of the method, apparatus, and non-transitory computer readable medium further include obtaining the plurality of tags comprises applying an image tagging model to the image.

Some examples of the method, apparatus, and non-transitory computer readable medium further include generating the plurality of image-tag descriptions includes generating one or more input prompts based on each of the plurality of tags; and generating, using the natural language model, the plurality of image-tag descriptions based on the one or more input prompts. Some examples of the method, apparatus, and non-transitory computer readable medium further include generating the description of the image comprises: generating an input prompt based on the plurality of image-tag descriptions; and summarizing, using the natural language model, the plurality of image-tag descriptions.

Some examples of the method, apparatus, and non-transitory computer readable medium further include generating a training set for a machine learning model including the image and the description of the image. Some examples of the method, apparatus, and non-transitory computer readable medium further include generating a prompt for an image generation model including the description of the image.

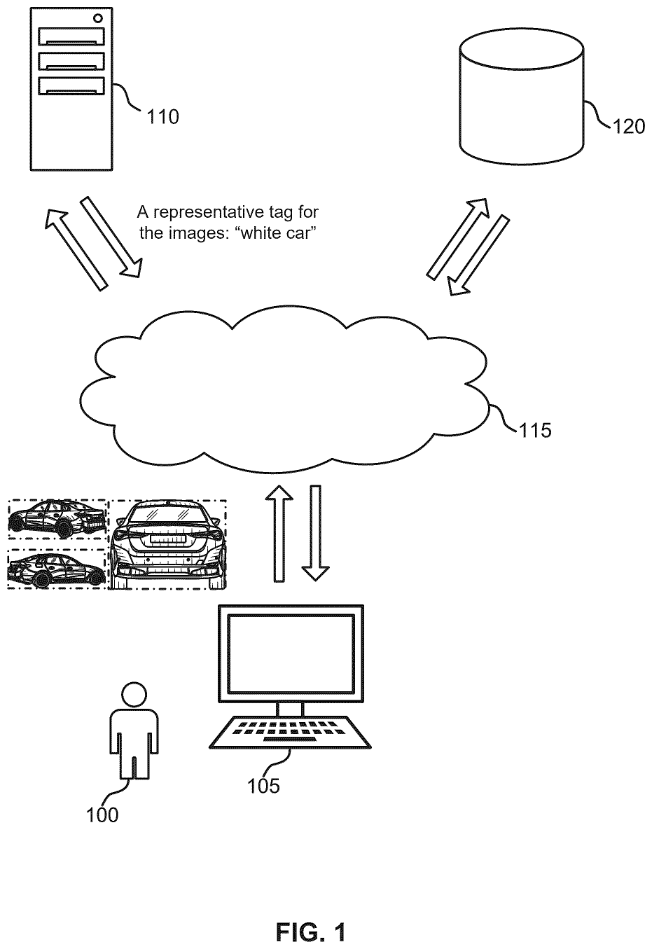

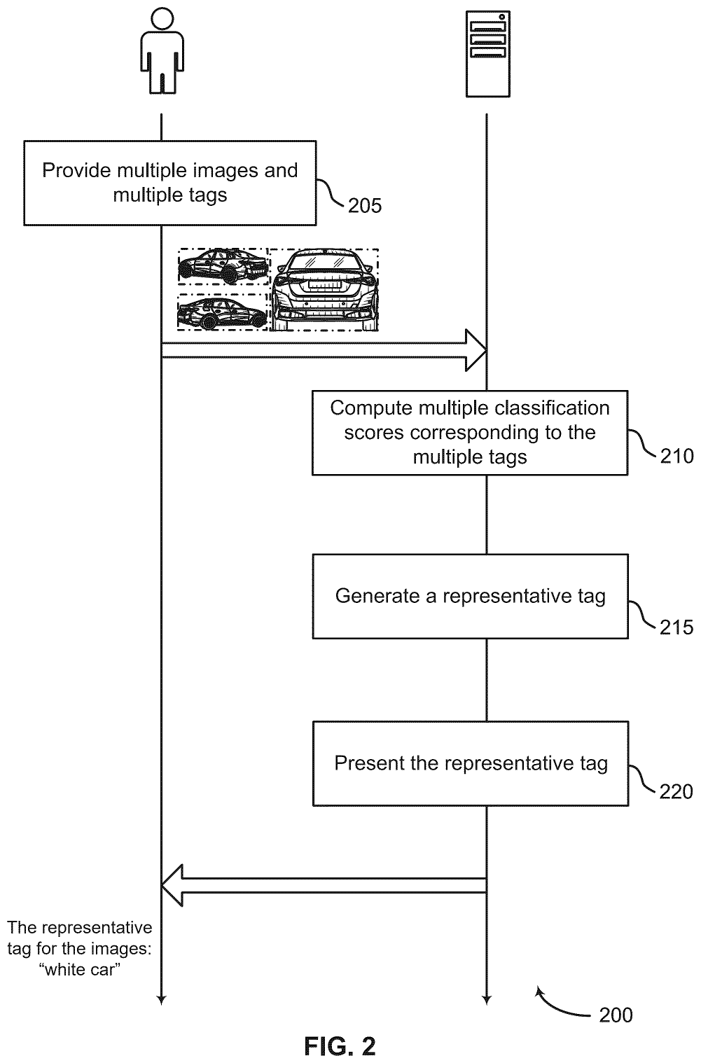

FIG. 1 shows an example of an image processing system according to aspects of the present disclosure. The image processing system is an example of, or includes aspects of, the corresponding element described with reference to FIGS. 2-5, 8, and 9.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIGS. 2-5, 8, and 9.

In the example shown in FIG. 1, user 100 provides multiple images of a white car to the image processing apparatus 110, e.g., via user device 105 and cloud 115. Image processing apparatus 110 then processes these images to capture the essence of the white car. For example, the apparatus employs multiple components, each configured to analyze specific aspects of the images. The tag extraction component generates captions for each image, describing the visual content and key elements present. The image-tag similarity component computes scores indicating the relevance or similarity of each image to a predefined set of categories or tags related to cars.

In this example, the encoded information from these components is then fed into the classification component of the apparatus. This component analyzes the classification scores across all the images and applies algorithms to identify the most representative tag for the set of white car images. The selection component then uses the output from the classification component to select a representative tag, such as “white car,” that captures the most salient or defining aspect of the white car present in the input images.

The generated representative tag is then returned to user 100 via cloud 115 and user device 105. The representative tag serves as a concise and informative label that encapsulates the essence of the white car depicted in the input images. The user can utilize this tag for various purposes, such as image search, retrieval, or organization. The final output demonstrates the apparatus's capability to transform a set of related images into a meaningful and representative tag. User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser. The process of using the image processing apparatus 110 is further described with reference to FIGS. 2-5, 8, and 9.

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 2-5, 8, and 9. Further detail regarding the operation of image processing apparatus 110 is provided with reference to FIGS. 2-5, 8, and 9.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of an image processing application 200 according to aspects of the present disclosure. The image processing application 200 is an example of, or includes aspects of, the corresponding element described with reference to FIGS. 1, 3-5, 8, and 9.

At operation 205, the user provides multiple images of a white car to the system. These images may be used as the input for the image analysis and tagging process. The image may depict different angles, poses, or variations of a white car. For example, the images may depict front, side, and rear views of the car, as well as close-ups of specific features like the headlights or wheels.

In some examples, the images can be captured in various settings or environments, such as a parking lot, a city street, or a dealership showroom. The system accepts these user-provided images and prepares them for further processing and analysis. For example, the system analyzes the visual content of the images and generates a representative tag that captures the essence of the white car depicted in the set.

At operation 210, the system computes multiple classification scores for each image in the provided set. The classification scores indicate the relevance or similarity of each image to a predefined set of categories or tags related to cars. The system employs advanced image recognition techniques, such as machine learning models trained on car-related datasets, to analyze the visual features and characteristics of each image.

In some examples, the system can identify and extract relevant information from the images, such as the car's color, shape, and style. The system assigns scores to various attributes or categories based on the presence and prominence of these features in each image. For example, the system may assign high scores to tags like “white,” “sedan,” “compact car,” or “alloy wheels” if the images strongly exhibit those characteristics.

At operation 215, the system selects a representative tag based on the computed classification scores. For example, the representative tag can be selected from among the tags of the input images. The representative tag aims to capture the most salient or defining aspect of the white car present in the set of input images. The system analyzes the classification scores across all the images and applies algorithms to identify the tag that best represents the common theme or dominant feature.

In some examples, the system generates tags such as “white car” with a confidence score of 51%, “car” with a confidence score of 49%, and “parked car” with a confidence score of 0%. The tag “white car” is selected as the representative tag since it captures the most prominent and consistent feature across the image set as the presence of a white-colored car.

At operation 220, the system presents the generated representative tag to the user. The representative tag may be used as a concise and informative label that encapsulates the essence of the white car depicted in the input images. The system displays the tag to the user through a user interface or incorporates it into the image metadata or database.

In some examples, the presented tag enables users to quickly grasp the main aspect or characteristic of the car without the need to examine each image individually. In an image search or retrieval application, the representative tag “white car” can be used to locate and display images of white cars from a larger collection. This enhances the efficiency of image organization and retrieval, allowing users to easily find and explore desired white car images.

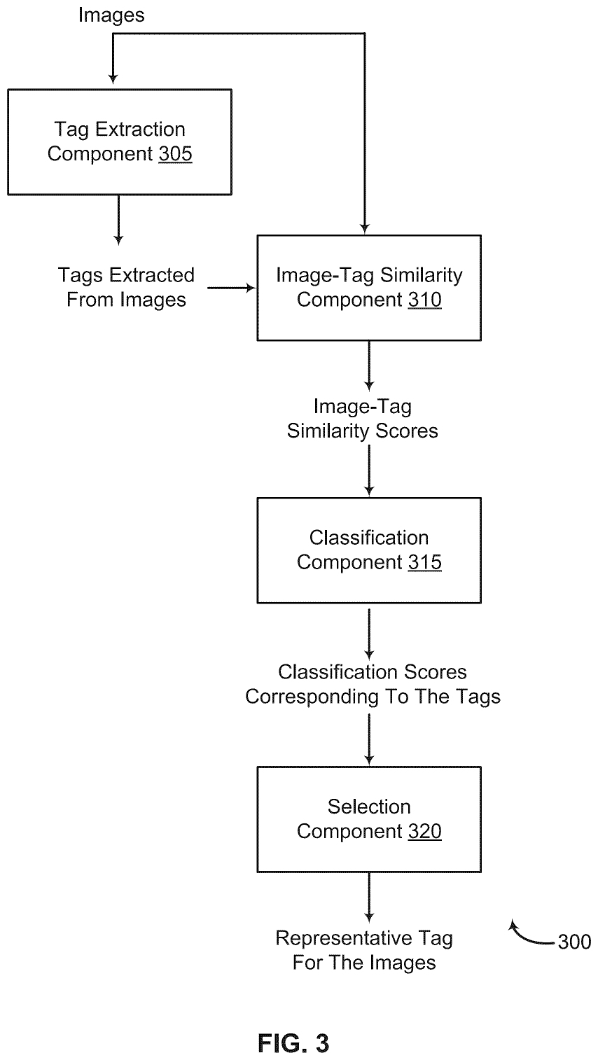

FIG. 3 shows an example of an image processing application 300 according to aspects of the present disclosure. The image processing application 300 is an example of, or includes aspects of, the corresponding element described with reference to FIGS. 1, 2, 4, 5, 8, and 9.

Referring to FIG. 3, image processing application 300 involves selecting a representative tag for a plurality of images with a tag extraction component 305. The tag extraction component 305 takes the plurality of images as input and generates a plurality of captions corresponding to the images. The captions provide descriptive information about the content and elements present in each image. The tag extraction component 305 then filters the captions by removing stopwords, which are common words that do not carry significant meaning, such as “a,” “an,” and “the.” From the filtered captions, the tag extraction component 305 extracts a plurality of tags that represent the key elements and concepts present in the images.

The extracted tags and the plurality of images are then passed to the image-tag similarity component 310. The image-tag similarity component 310 encodes each image and tag into embeddings in a multi-modal embedding space. This allows for the comparison of images and tags in a common representational space. The image-tag similarity component 310 computes cosine similarities between each image embedding and each tag embedding, resulting in a plurality of image-tag similarity scores. These scores indicate the degree of similarity or relevance between each image and each tag. Additionally, image-tag similarity component 310 measures the variance of dimensions across the image embeddings for each tag and scales the dimensions based on the measured variance. This scaling process gives higher importance to dimensions that are consistent across the images, as they are more likely to capture the common concept or theme.

The image-tag similarity scores are then passed to classification component 315. The classification component 315 computes classification scores for each tag by averaging the corresponding subset of image-tag similarity scores. This averaging process helps to determine the overall relevance or representativeness of each tag across all the images. The classification component 315 also computes the sum of image-tag similarity scores for each tag over all the images and divides the sum by the count of images. This normalization step ensures that the classification scores are comparable across different tags. Furthermore, the classification component 315 ranks the tags based on their classification scores, allowing for the identification of the most relevant or representative tags for the given set of images.

Subsequently, the classification scores and the ranked list of tags are passed to the selection component 320. The selection component 320 selects the tag with the highest classification score as the representative tag for the plurality of images. This representative tag captures the most salient and common concept or theme present in the input images. By identifying the representative tag, the image processing apparatus 300 provides a concise and meaningful label that summarizes the content and characteristics of the image set as a whole.

The output of image processing apparatus 300 includes the representative tag for the plurality of images. This tag representative can be used for image categorization, retrieval, and organization. By automatically selecting a representative tag, the image processing apparatus 300 eliminates the need for manual annotation and ensures consistency in labeling across large sets of images. In some examples, the representative tag provides a high-level understanding of the common theme or concept present in the images, enabling efficient search, grouping, and analysis of visual content.

An apparatus for captioning is described. One or more aspects of the apparatus include at least one processor; at least one memory storing instruction executable by the at least one processor; an image-tag similarity component comprising parameters stored in the at least one memory and configured to compute a plurality of image-tag similarity scores, wherein each of the plurality of image-tag similarity scores indicate a similarity between one of a plurality of images and one of a plurality of tags, wherein each of the plurality of tags represents a corresponding element of at least one of the plurality of images; a classification component comprising parameters stored in the at least one memory and configured to compute a plurality of classification scores corresponding to the plurality of tags, respectively, by averaging a subset of the plurality of image-tag similarity scores corresponding to each of the plurality of tags; and a selection component comprising parameters stored in the at least one memory and configured to generate a tag representing the plurality of images based on the tag having a highest classification score among the plurality of classification scores.

Some examples of the apparatus and method further include a tag extraction component configured to generate a plurality of captions corresponding to the plurality of images, respectively, and to extract the plurality of tags from the plurality of captions. In some aspects, the tag extraction component is further configured to filter the plurality of captions by removing a set of stopwords.

In some aspects, the image-tag similarity component is further configured to encode each of the plurality of images and each of the plurality of tags to obtain a plurality of image embeddings and a plurality of text embeddings in a multi-modal embedding space and to compute a cosine similarity between each of the plurality of image embeddings and each of the plurality of text embeddings. In some aspects, the image-tag similarity component is further configured to compute a measure of a variance of a dimension across the plurality of image embeddings for each of the plurality of tags and to scale the dimension of the plurality of image embeddings based on the measure of the variance.

In some aspects, the classification component is further configured to compute, for each of the plurality of tags, a sum of the image-tag similarity scores over each of the plurality of images, and to divide the sum by a count of the plurality of images. In some aspects, the classification component is further configured to rank the plurality of tags based on the corresponding classification scores, and select the representative tag based on the ranking.

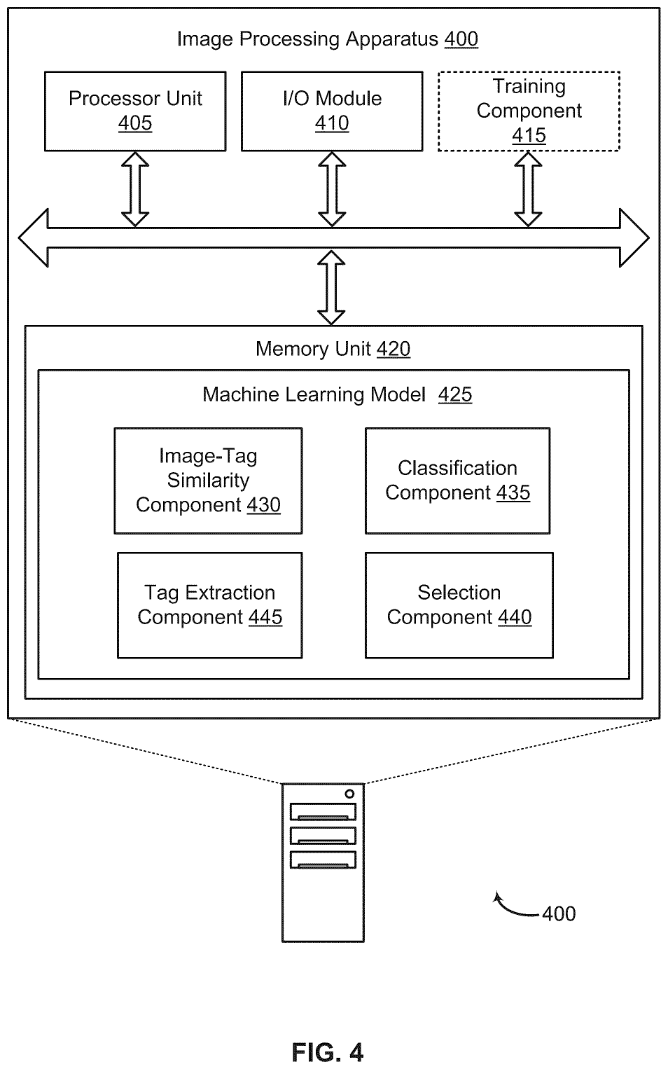

FIG. 4 shows an example of an image processing apparatus 400 according to aspects of the present disclosure. The image processing apparatus 400 is an example of, or includes aspects of, the corresponding element described with reference to FIGS. 1-3, 5, 8, and 9. In one aspect, image processing apparatus 400 includes processor unit 405, I/O module 410, training component 415, memory unit 420, and machine learning model 425. Machine learning model 425 includes image-tag similarity component 430, tax extraction component 445, classification component 435, and selection component 440.

Processor unit 405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 405 is configured to operate a memory array using a memory controller. In other cases, a memory controller is integrated into processor unit 405. In some cases, processor unit 405 is configured to execute computer-readable instructions stored in memory unit 420 to perform various functions. In some aspects, processor unit 405 includes special purpose components for modem processing, baseband processing, digital signal processing, or transmission processing. According to aspects, processor unit 405 comprises one or more processors described with reference to FIGS. 1-3, 5, 8, and 9.

Memory unit 420 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 405 to perform various functions described herein.

In some cases, memory unit 420 includes a basic input/output system (BIOS) that controls basic hardware or software operations, such as an interaction with peripheral components or devices. In some cases, memory unit 420 includes a memory controller that operates memory cells of memory unit 420. For example, the memory controller may include a row decoder, column decoder, or both. In some cases, memory cells within memory unit 420 store information in the form of a logical state. According to aspects, memory unit 420 comprises the memory subsystem described with reference to FIGS. 1-3, 5, 8, and 9.

According to aspects, image generation apparatus 400 uses one or more processors of processor unit 405 to execute instructions stored in memory unit 420 to perform functions described herein. For example, in some cases, the image generation apparatus 400 obtains a prompt describing an image element. For example, the image element may correspond to a plurality of concepts.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Referring to FIG. 4, a machine learning model 425 for selecting a representative tag for a plurality of images is depicted. The machine learning model 425 comprises an image-tag similarity component 430, a tag extraction component 445, a classification component 435, and a selection component 440. In some examples, machine learning model 425 is a natural language model.

The tag extraction component 445 may generate captions for each input image and extract relevant tags from the captions. For example, tag extraction component 445 takes the plurality of images as input and applies natural language processing techniques to generate descriptive captions for each image. The captions aim to capture the content and elements present in the images. The tag extraction component 445 then filters the captions by removing stopwords, which are common words that do not carry significant meaning, such as “a,” “an,” and “the.” From the filtered captions, the tag extraction component 445 extracts a plurality of tags that represent the key concepts and objects present in the images.

The image-tag similarity component 430 takes the extracted tags and the plurality of images as input and computes the similarity between each image and each tag. For example, The image-tag similarity component 430 encodes the images and tags into embeddings in a multi-modal embedding space, allowing for the comparison of visual and textual information in a common representational space. For example, the image-tag similarity component 430 computes cosine similarities between each image embedding and each tag embedding, resulting in a plurality of image-tag similarity scores. These scores indicate the degree of relevance or alignment between each image and each tag.

In some examples, image-tag similarity component 430 may measure the variance of dimensions across the image embeddings for each tag and scales the dimensions based on the measured variance. This scaling process gives higher importance to dimensions that are consistent across the images, as they are more likely to capture the common concept or theme.

The classification component 435 receives the image-tag similarity scores from the image-tag similarity component 430 and computes classification scores for each tag. It averages the corresponding subset of image-tag similarity scores for each tag, determining the overall relevance or representativeness of each tag across all the images. In some examples, the classification component 435 computes the sum of image-tag similarity scores for each tag over all the images and divides the sum by the count of images. This normalization step may ensure that the classification scores are comparable across different tags. In some examples, classification component 435 ranks the tags based on their classification scores, allowing for the identification of the most relevant or representative tags for the given set of images.

For example, classification component 435 performs zero-shot classification per image by determining which word or bigram has highest cosine similarity in the latent space. For example, this may be determined based on how often a word or bigram repeats across captions. This step may upweight words that appear in multiple captions.

The selection component 440 receives the classification scores and the ranked list of tags from the classification component 435. The selection component 440 selects the tag with the highest classification score as the representative tag for the plurality of images. This representative tag captures the most salient and common concept or theme present in the input images. By identifying the representative tag, the machine learning model 425 provides a concise and meaningful label that summarizes the content and characteristics of the image set as a whole.

The output of the machine learning model 425 may include the representative tag for the plurality of images. This tag can be used for various purposes, such as image categorization, retrieval, and organization. By automating the process of selecting a representative tag, the machine learning model 425 eliminates the need for manual annotation and ensures consistency in labeling across large sets of images. The representative tag provides a high-level understanding of the common theme or concept present in the images, enabling efficient search, grouping, and analysis of visual content.

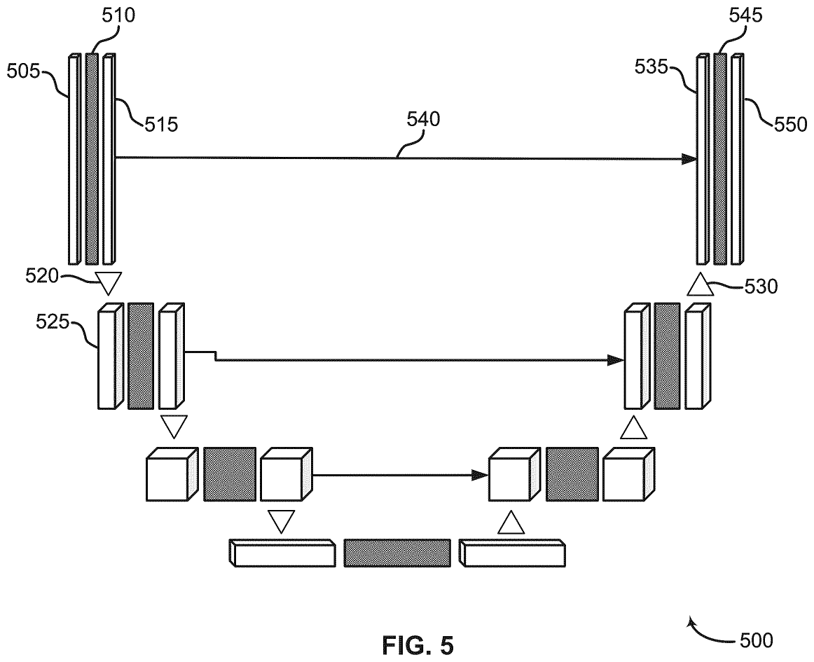

FIG. 5 shows an example of an image processing model 500 according to aspects of the present disclosure. The image processing model 500 is an example of, or includes aspects of, the corresponding element described with reference to FIGS. 1-4, 8, and 9. According to some aspects, image generation model 500 comprises a diffusion model including an ANN architecture such as a U-Net.

According to some aspects, image generation model 500 receives input features 505, where input features 505 include an initial resolution and an initial number of channels, and processes input features 505 using an initial neural network layer 510 (e.g., a convolutional neural network layer) to produce intermediate features 515. In some cases, intermediate features 515 are then down-sampled using a down-sampling layer 520 such that down-sampled features 525 have a resolution less than the initial resolution and a number of channels greater than the initial number of channels.

In some cases, this process is repeated multiple times, and then the process is reversed. For example, down-sampled features 525 are up-sampled using up-sampling process 530 to obtain up-sampled features 535. In some cases, up-sampled features 535 are combined with intermediate features 515 having the same resolution and number of channels via skip connection 540. In some cases, the combination of intermediate features 515 and up-sampled features 535 are processed using final neural network layer 545 to produce output features 550. In some cases, output features 550 have the same resolution as the initial resolution and the same number of channels as the initial number of channels.

According to some aspects, image generation model 500 receives additional input features to produce a conditionally generated output. In some cases, the additional input features include a vector representation of an input prompt. In some cases, the additional input features are combined with intermediate features 515 within Image generation model 500 at one or more layers. For example, in some cases, a cross-attention module is used to combine the additional input features and intermediate features 515.

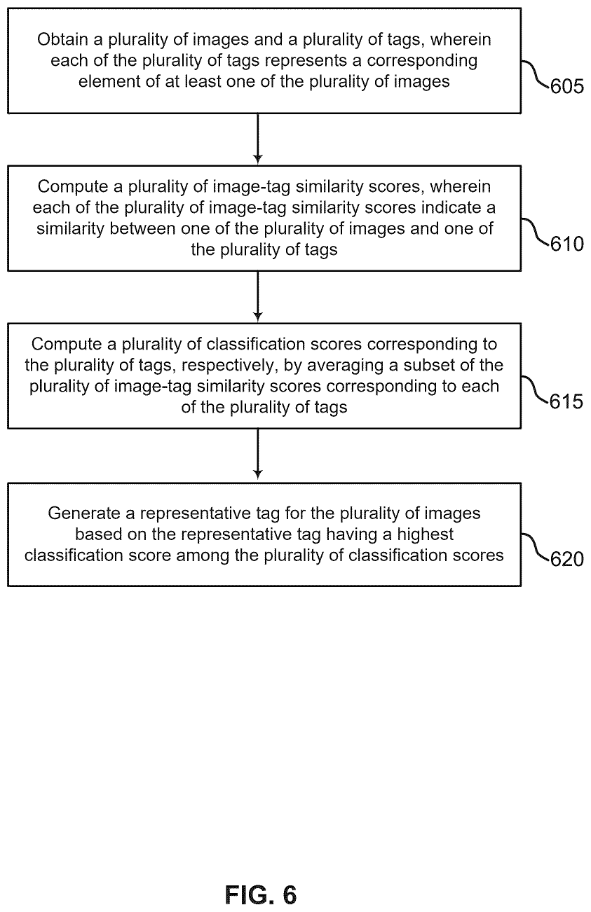

FIG. 6 shows an example of method 600 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a set of images and a set of tags, where each of the set of tags represents a corresponding element of at least one of the set of images. In some cases, the operations of this step refer to, or may be performed by, a tag extraction component as described with reference to FIGS. 1-5, and 8-9.

For example, at operation 605, the system may receive a set of user-uploaded images depicting various products or scenes. Along with the images, the system also obtains a set of tags that describe the key elements or concepts present in each image. In some examples, these tags are generated automatically by the system using image analysis techniques, such as object detection or image classification. In some examples, these tags can be provided by the users who uploaded the images. The users may be human users or machines. In some examples, the obtained tags serve as initial descriptors of the visual content and help in establishing a baseline understanding of the image set.

At operation 610, the system computes a set of image-tag similarity scores, where each of the set of image-tag similarity scores indicate a similarity between one of the set of images and one of the set of tags. In some cases, the operations of this step refer to, or may be performed by, an image-tag similarity component as described with reference to FIGS. 1-5, and 8-9.

For example, at operation 610, the system employs techniques such as multi-modal embedding or cosine similarity, to measure the semantic similarity between the visual features of each image and the textual representation of each tag. For example, this involves projecting both the images and tags into a shared embedding space, where similar images and tags are positioned closer together. The resulting image-tag similarity scores provide a quantitative measure of how well each tag aligns with the content of each image. In some examples, the image-tag similarity scores can be used for the system to assess the relevance and appropriateness of the tags for describing the images.

At operation 615, the system computes a set of classification scores corresponding to the set of tags, respectively, by averaging a subset of the set of image-tag similarity scores corresponding to each of the set of tags. In some cases, the operations of this step refer to, or may be performed by, a classification component as described with reference to FIGS. 1-5, and 8-9.

For example, at operation 615, the system groups the image-tag similarity scores based on their corresponding tags and calculates the average score for each tag across all the images in the set. This averaging process helps to determine the overall representativeness of each tag to the entire image collection. In some examples, tags with higher average similarity scores are considered more relevant and descriptive of the common themes or elements shared by the majority of the images. The system may further refine the classification scores by applying additional techniques, such as weighting or normalization, to account for factors like tag frequency or image diversity, ensuring a balanced and accurate representation of the tags.

At operation 620, the system generates a representative tag for the set of images based on the representative tag having the highest classification score among the set of classification scores. In some cases, the operations of this step refer to, or may be performed by, a selection component as described with reference to FIGS. 1-5, and 8-9.

For example, at operation 620, the system ranks the tags based on their classification scores and selects the tag with the highest score as the representative tag for the image set. In some examples, this representative tag serves as a concise and informative label that captures the most salient or dominant concept shared by the images. In some examples, when multiple tags have similar high scores, the system may employ additional criteria, such as tag specificity or coherence with the image content, to determine the most suitable representative tag. The selected representative tag can be used for various applications, such as image categorization, retrieval, or summarization, enabling users to quickly grasp the main theme or subject matter of the image collection without necessarily examining each image individually.

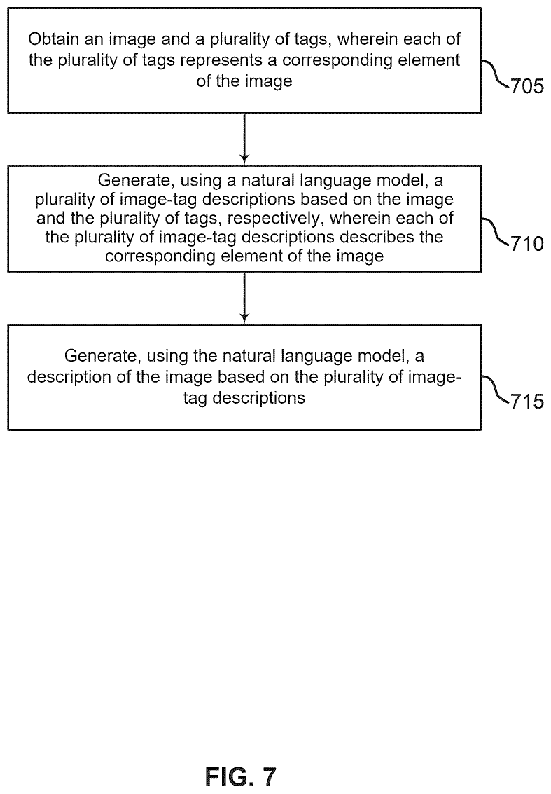

FIG. 7 shows an example of method 700 for natural language processing according to aspects of the present disclosure. In some examples, these operations are performed by a system including a processor executing a set of codes to control functional elements of an apparatus. Additionally or alternatively, certain processes are performed using special-purpose hardware. These operations are performed according to the methods and processes described in accordance with aspects of the present disclosure. In some cases, the operations described herein are composed of various substeps, or are performed in conjunction with other operations.

At operation 705, the system obtains an image and a set of tags, where each of the set of tags represents a corresponding element of the image. In some cases, the operations of this step refer to, or may be performed by, a tag extraction component as described with reference to FIGS. 1-5, and 8-9.

For example, at operation 705, the system may receive a set of input images from a user or retrieve it from a database. The input images could be photographs, digital artworks, or other types of visual contents. In addition to the input image, the system also obtains a set of tags that describe the key elements or objects present in the image. These tags can be generated automatically by the system using image recognition algorithms or provided by the user who uploaded the image. The tags serve as initial labels or annotations that identify the main components or features of the image, such as “person,” “car,” “building,” or “landscape.”

At operation 710, the system generates, using a natural language model, a set of image-tag descriptions based on the image and the set of tags, respectively, where each of the set of image-tag descriptions describes the corresponding element of the image. In some cases, the operations of this step refer to, or may be performed by, an image-tag similarity component as described with reference to FIGS. 1-5, and 8-9.

For example, at operation 710, the system employs a pre-trained natural language model, such as GPT or BERT, to generate detailed and contextually relevant descriptions for each tag in the image. The model takes the image and a specific tag as input and produces a natural language description that elaborates on the visual characteristics, attributes, or actions associated with that particular element. For example, given an image of a person riding a bike and the tag “person,” the model may generate a description. These image-tag descriptions provide a more comprehensive and expressive representation of the image content compared to the original tags alone.

At operation 715, the system generates, using the natural language model, a description of the image based on the set of image-tag descriptions. In some cases, the operations of this step refer to, or may be performed by, a natural language model as described with reference to FIGS. 1-5, and 8-9. In some examples, using the natural language model involves employing a multimodal language model using chain of thought (CoT) prompting strategy. The CoT prompting strategy may prompt the model to break down a complex problem into a series of intermediate reasoning steps, generating an output at a step that serves as input for the next.

For example, at operation 715, the system utilizes the natural language model to generate an overall description of the image by considering all the image-tag descriptions collectively. The model takes the set of image-tag descriptions as input and generates a coherent and concise summary that captures the main theme, context, or narrative of the image. This final description integrates the information from the individual tag descriptions and provides a high-level overview of the image content. For example, given the image-tag descriptions for various elements like “person,” “bike,” “trail,” and “forest,” the model may generate a final description serves as a comprehensive and human-readable representation of the image, enabling better understanding and engagement with the visual content.

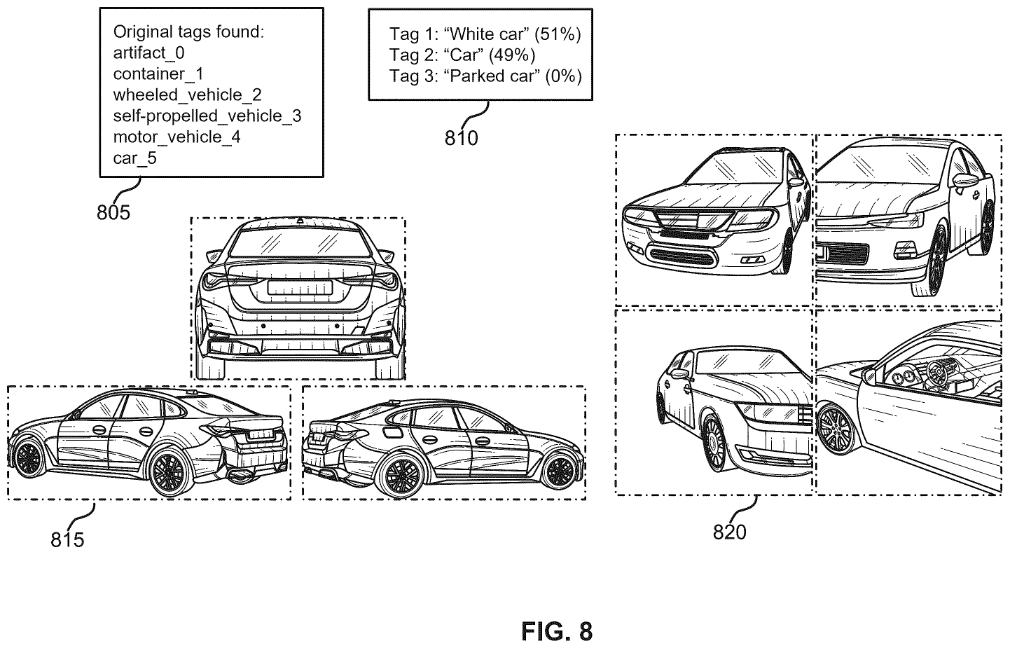

FIG. 8 shows examples of an image processing application according to aspects of the present disclosure. The examples include aspects of the corresponding element described with reference to FIGS. 1-5, and 9.

Referring to FIG. 8, examples of selecting a representative tag for a plurality of images and the comparison with a control group are provided. The input to the system includes a set of original tags 805 found from the plurality of images 815. In this example, the original tags 805 comprise terms such as “artifact,” “container,” “wheeled vehicle,” “self-propelled vehicle,” “motor vehicle,” and “car.” These tags provide a basic description of the objects and concepts present in the images but may lack specificity or fail to capture the most salient aspects of the image set as a whole.

The system takes the original tags 805 and the plurality of images 815 as input and processes them through its various components, including the tag extraction component, image-tag similarity component, classification component, and selection component. The system generates a plurality of new tags and ranks them based on their relevance and representativeness to the entire image set.

The generated tags 810 demonstrate the system's ability to identify more specific and relevant labels for the given set of images. In this example, the top-ranked tag, “Tag 1,” is “white car” with a confidence score of 51%. This tag captures the most salient and common concept present in the images, which is the presence of a white car. The second-ranked tag, “Tag 2,” is “car” with a confidence score of 49%. While less specific than “Tag 1,” it still accurately describes the main object in the images. The third-ranked tag, “Tag 3,” is “parked car” with a confidence score of 0%, indicating that it is not a relevant or representative label for the given image set.

In FIG. 8, control group 820 is present to highlight the effectiveness of the system. The control group demonstrates the results of generating images directly using the original tags 805 without the system's tag generation and selection process. For example, the images in control group 820 are shown to be of low resolution and fail to faithfully represent the content and characteristics of the plurality of images 815. For example, the generated images in control group 820 may not depict the same type of car as seen in the original images, or they may lack the specific details and attributes present in the image set.

By comparing the generated tags 810 and the control group 820, FIG. 8 illustrates the system's ability to generate more accurate, specific, and representative tags for a given set of images. The system's tag generation and selection process take into account the visual content and similarities across the images, enabling it to identify the most salient and common concepts. In contrast, the control group, which relies on the original tags, fails to capture the essential aspects of the images and generates results that are less relevant and visually inconsistent with the original image set.

The examples in FIG. 8 demonstrate the effectiveness of the system in generating representative tags for a plurality of images. By leveraging advanced techniques such as image-tag similarity analysis, classification, and selection, the system provides a more accurate and meaningful way to summarize and label image sets compared to using only the original tags. This enables better organization, retrieval, and understanding of visual content, as the generated tags capture the core concepts and characteristics of the images in a concise and relevant manner.

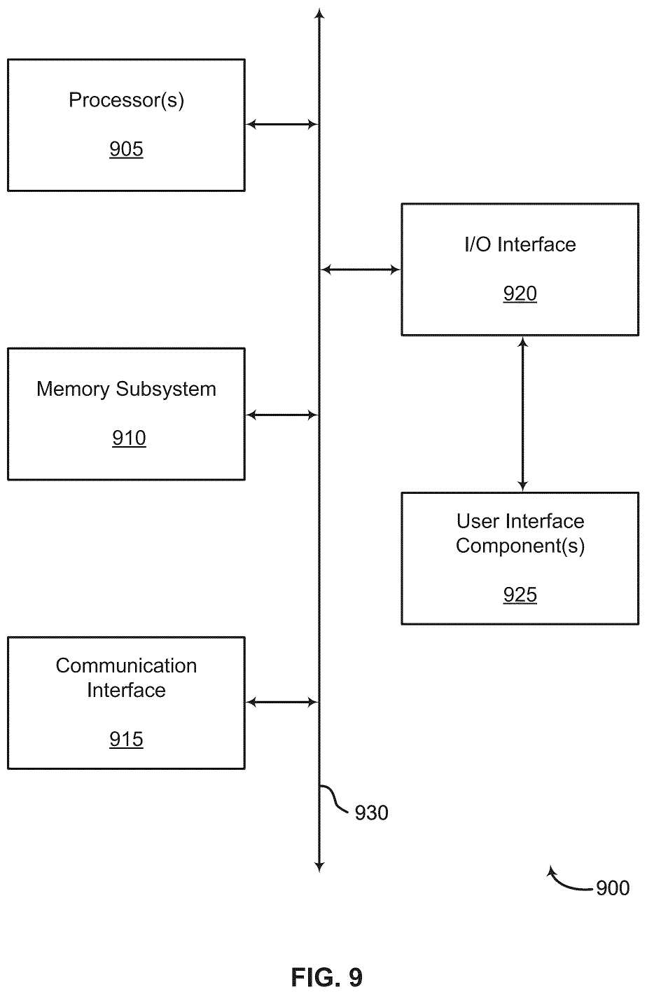

FIG. 9 shows an example of a computing device 900 according to aspects of the present disclosure. The computing device 900 is an example of, or includes aspects of, the corresponding element described with reference to FIGS. 1-5, and 8.

The computing device 900 includes processor(s) 905, memory subsystem 910, communication interface 915, I/O interface 920, user interface component(s) 925, and channel 930. In some embodiments, computing device 900 includes one or more processors 905 that can execute instructions stored in memory subsystem 910 to generate synthetic images comprising a first attribute and a second attribute by providing a first attribute token to a first set layers of the image generation model during a first set of time-steps and providing a second attribute token to a second set of layers of the image generation model during a second set of time-steps

According to some aspects, computing device 900 includes one or more processors 905. Processor(s) 905 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 910 includes one or more memory devices. Memory subsystem 910 is an example of, or includes aspects of, the memory unit as described with reference to FIGS. 1-5, and 8. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component 925 enables a user to interact with computing device 900. In some cases, user interface component 925 includes an audio device, such as an external speaker system, an external display device such as a display screen, an input device (e.g., a remote-control device interfaced with a user interface directly or through the I/O controller), or a combination thereof. In some cases, user interface component 925 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a plurality of images and a plurality of tags, wherein each of the plurality of tags represents a corresponding element of at least one of the plurality of images;
computing a plurality of image-tag similarity scores, wherein each of the plurality of image-tag similarity scores indicate a similarity between one of the plurality of images and one of the plurality of tags;
computing a plurality of classification scores corresponding to the plurality of tags, respectively, by averaging a subset of the plurality of image-tag similarity scores corresponding to each of the plurality of tags; and
selecting a representative tag for the plurality of images based on the representative tag having a highest classification score among the plurality of classification scores.

2. The method of claim 1, wherein obtaining the plurality of tags comprises:
generating a plurality of captions corresponding to the plurality of images, respectively; and
extracting the plurality of tags from the plurality of captions.

3. The method of claim 2, further comprising:
filtering the plurality of captions by removing a set of stopwords.

4. The method of claim 1, wherein computing the plurality of image-tag similarity scores comprises:
encoding each of the plurality of images and each of the plurality of tags to obtain a plurality of image embeddings and a plurality of text embeddings in a multi-modal embedding space; and
computing a cosine similarity between each of the plurality of image embeddings and each of the plurality of text embeddings.

5. The method of claim 4, further comprising:
computing a measure of a variance of a dimension across the plurality of image embeddings for each of the plurality of tags; and
scaling the dimension of the plurality of image embeddings based on the measure of the variance.

6. The method of claim 1, wherein computing the plurality of classification scores further comprises:
computing, for each of the plurality of tags, a sum of the image-tag similarity scores over each of the plurality of images; and
dividing the sum by a count of the plurality of images.

7. The method of claim 1, wherein generating the representative tag comprises:
ranking the plurality of tags based on the corresponding classification scores; and
selecting the representative tag based on the ranking.

8. A method comprising:
obtaining an image and a plurality of tags, wherein each of the plurality of tags represents a corresponding element of the image;
generating, using a natural language model, a plurality of image-tag descriptions based on the image and the plurality of tags, respectively, wherein each of the plurality of image-tag descriptions describes the corresponding element of the image; and
generating, using the natural language model, a description of the image based on the plurality of image-tag descriptions.

9. The method of claim 8, wherein obtaining the plurality of tags comprises:
applying an image tagging model to the image.

10. The method of claim 8, wherein generating the plurality of image-tag descriptions comprises:
generating one or more input prompts based on each of the plurality of tags; and
generating, using the natural language model, the plurality of image-tag descriptions based on the one or more input prompts.

11. The method of claim 8, wherein generating the description of the image comprises:
generating an input prompt based on the plurality of image-tag descriptions; and
summarizing, using the natural language model, the plurality of image-tag descriptions.

12. The method of claim 8, further comprising:
generating a training set for a machine learning model including the image and the description of the image.

13. The method of claim 8, further comprising:
generating a prompt for an image generation model including the description of the image.

14. An apparatus comprising:
at least one processor;
at least one memory storing instruction executable by the at least one processor;
an image-tag similarity component comprising parameters stored in the at least one memory and configured to compute a plurality of image-tag similarity scores, wherein each of the plurality of image-tag similarity scores indicate a similarity between one of a plurality of images and one of a plurality of tags, wherein each of the plurality of tags represents a corresponding element of at least one of the plurality of images;
a classification component comprising parameters stored in the at least one memory and configured to compute a plurality of classification scores corresponding to the plurality of tags, respectively, by averaging a subset of the plurality of image-tag similarity scores corresponding to each of the plurality of tags; and
a selection component comprising parameters stored in the at least one memory and configured to generate a tag representing the plurality of images based on the tag having a highest classification score among the plurality of classification scores.

15. The apparatus of claim 14, further comprising:
a tag extraction component configured to generate a plurality of captions corresponding to the plurality of images, respectively, and to extract the plurality of tags from the plurality of captions.

16. The apparatus of claim 15, wherein the tag extraction component is further configured to filter the plurality of captions by removing a set of stopwords.

17. The apparatus of claim 14, wherein the image-tag similarity component is further configured to encode each of the plurality of images and each of the plurality of tags to obtain a plurality of image embeddings and a plurality of text embeddings in a multi-modal embedding space and to compute a cosine similarity between each of the plurality of image embeddings and each of the plurality of text embeddings.

18. The apparatus of claim 17, wherein the image-tag similarity component is further configured to compute a measure of a variance of a dimension across the plurality of image embeddings for each of the plurality of tags and to scale the dimension of the plurality of image embeddings based on the measure of the variance.

19. The apparatus of claim 14, wherein the classification component is further configured to compute, for each of the plurality of tags, a sum of the image-tag similarity scores over each of the plurality of images, and to divide the sum by a count of the plurality of images.

20. The apparatus of claim 14, wherein the classification component is further configured to rank the plurality of tags based on the corresponding classification scores, and select the representative tag based on the ranking.
